(19) United States
(12) Patent Application Publication
(10) Pub. No.: US 2020/0202702 A1
(43) Pub. Date: Jun. 25, 2020

(54) INFRARED REMOTE CONTROLLER BASED ON VOICE CONTROL AND CONTROL SYSTEM FOR ELECTRICAL APPARATUS

(71) Applicant: SHENZHEN LENKENG TECHNOLOGY CO., LTD., Shenzhen City (CN)

(72) Inventor: BINGHAI GAO, Shenzhen City (CN)

(21) Appl. No.: 16/442,450

(22) Filed: Jun. 14, 2019

(30) Foreign Application Priority Data
Dec. 20, 2018 (CN) 201811566972.1

(51) Int. Cl. G08C 23/04; G10L 15/02; G10L 15/20; G10L 15/22; G10L 21/0208

(52) U.S. Cl. CPC G08C 23/04; G10L 15/02; G08C 2201/92; G10L 15/22; G10L 21/0208; G10L 15/20

(57) ABSTRACT

An infrared remote controller based on voice control includes a first collecting module collecting user's voice data, a voice recognition module recognizing a command from the user's voice data and generating an electrical signal according to the command, and an infrared emitter converting the electrical signal to an infrared signal and sending the infrared signal to an electrical apparatus to control the electrical apparatus.

### CROSS REFERENCE TO RELATED APPLICATIONS

Pursuant to 35 U.S.C. § 119, this application claims foreign priority to Chinese Patent Application No. 201811566972.1 filed in Dec. 20, 2018, the contents of which, including any intervening amendments thereto, are incorporated herein by reference.

### TECHNICAL FIELD

The present disclosure relates to an infrared control technology, in particular to an infrared remote controller based on voice control and a control system for electrical apparatus.

### BACKGROUND

With the rise of intelligent life and smart homes, using voice commands to control smart home has become an emerging technology. Typically, in a voice command control system for electronic apparatus, voice recognition and conversion are key functions of the voice command control system. When the voice recognition and conversion function are performed, first, a voice command from a user is collected, second, the features of the collected voice commands are extracted, and third, the extracted voice features are recognized. Such that the content of the voice commands and identification of the user are recognized.

Since voice collection and voice conversion are the key functions of voice command control system, how to improve the accuracy of voice collection and voice conversion in an infrared remote controller device, and transmit the voice control command to ensure to correctly control the electronic apparatus are desired to solve in those skilled in the art.

### SUMMARY

In order to overcome the deficiencies of the prior art, the present disclosure provides an infrared remote controller based on voice control and a control system for electrical apparatus.

The objective of the present disclosure is achieved by the following technical solutions:

The infrared remote controller based on voice control includes a first collecting module collecting user's voice data, a voice recognition module recognizing an command from the user's voice data and generating an electrical signal according to the command, and an infrared emitter converting the electrical signal to an infrared signal and sending the infrared signal to an electrical apparatus to control the electrical apparatus.

Preferably, the infrared remote controller further includes a preprocessing module, the preprocessing module preprocesses the user's voice data collected by the first collecting module to acquire target voice.

Preferably, the infrared remote controller further includes a storage module storing preset voice commands including the preset voice feature.

Preferably, the preprocessing module includes an interference suppression unit electrically connected to the first collecting module and a noise filtering unit; the interference suppression unit processes the user's voice data collected by the first collecting module to acquire a voice data with a high signal-to-noise ratio; the noise filtering unit is electrically connected to the interference suppression unit, and processes the voice data with the high signal-to-noise ratio to acquire the target voice.

Preferably, the infrared emitter is connected to the voice recognition module, the infrared emitter receives and analyzes a first feedback signal sent by the voice recognition module to generate the infrared signal according to the first feedback signal, and sends the infrared signal to the electrical apparatus.

Preferably, the infrared emitter includes an infrared receiving unit and a voice binding unit; the infrared receiving unit is connected to the storage module and a control unit, and receives and analyzes the infrared signal into data of an analyzed infrared signal, and stores the data of the analyzed infrared signal in the storage module; the voice binding unit is connected to the storage module, and binds the data of the analyzed infrared signal with a preset voice command pre-stored in the storage module.

Preferably, the infrared remote controller further includes a second collecting module connected to the preprocessing module; the second collecting module acquires an ambient noise, and analyzes and feeds back a noise level of the ambient noise to the preprocessing module, and the preprocessing module adjusts a noise filtering intensity according to the noise level of the ambient noise.

Preferably, the preprocessing module further includes a signal compensation unit, and the signal compensation unit is connected to a noise filtering unit, the signal compensation unit compensates data loss of voice commands when the interference suppression unit and the noise filtering unit process noise.

A control system for an electrical apparatus includes an electrical apparatus and an infrared remote controller based on voice control. The infrared remote controller includes a first collecting module collecting user's voice data, a voice recognition module recognizing a command from the user's voice data and generating an electrical signal according to the command, and an infrared emitter converting the electrical signal to an infrared signal and sending the infrared signal to the electrical apparatus to control the electrical apparatus.

Compared with the prior art, the wireless transmitting device of the disclosure has the following advantages:

Firstly, the user's preset voice command is stored locally by the storage module, and the preset voice command data can be used quickly without using the cloud to store the voice command. The first collecting module is configured to receive the user's voice data, the interference suppression unit of the preprocessing module is configured to suppress the interference signal in the voice data from the first collecting module to improve the signal-to-noise ratio of the voice data from the first collecting module, and the noise filtering unit is configured to further eliminate the interference signal to effectively preserve the user's voice in the voice data, that is, the target voice. The voice recognition module is configured to extract the voice feature of the target voice from the preprocessing module, and compare the voice feature of the target voice with the preset voice feature stored in the storage module. If the ratio of the voice feature of the target voice to the preset voice feature is greater than or equal to the speech feature matching threshold, the voice recognition module sends the first feedback signal to the infrared emitter, and the infrared emitter sends the infrared signal to control the electrical apparatus.

Further, the first collecting module is detachably connected to the preprocessing module in a wired manner, which ensures the signal transmission between the first collecting module and the preprocessing module to be stable, thereby improving preprocessing effect of the preprocessing module.

Secondly, the user may effectively extend the preset voice command through the self-setting voice collection module and the voice binding module. Thus, the plurality of voice commands can be used to control the same action of the electrical apparatus, thereby effectively avoiding the user's inability to control the electrical apparatus because of forgetting the voice command.

Thirdly, the second collecting module is configured to acquire the ambient noise, analyze the noise level of the ambient noise, and send the second feedback signal of the noise level to the preprocessing module, and thus the preprocessing module may adjust the filtering strength of the noise according to the different noise levels to acquire the relative good target voice, which increases the sound recognition effect.

### BRIEF DESCRIPTION OF THE DRAWINGS

FIG. 1 is a block diagram of an infrared remote controller based on voice control according to a first embodiment.

FIG. 2A is a block diagram of a first collecting module of the infrared remote controller based on voice control according to the embodiment.

FIG. 2B is a block diagram of another first collecting module of the infrared remote controller based on voice control according to the embodiment.

FIG. 3 is a block diagram of a preprocessing module of the infrared remote controller based on voice control according to the embodiment.

FIG. 4 is a block diagram of a voice recognition module of the infrared remote controller based on voice control according to the embodiment.

FIG. 5 is a block diagram of an infrared emitter of the infrared remote controller based on voice control according to the embodiment.

FIG. 6A is a block diagram of an infrared remote controller based on voice control according to a second embodiment.

FIG. 6B is a block diagram of a voice binding module of the infrared remote controller based on voice control according to the second embodiment.

FIG. 7 is a block diagram of an infrared remote controller based on voice control according to a third embodiment.

FIG. 8 is a block diagram of an infrared receiving unit of an infrared remote controller based on voice control according to the third embodiment.

FIG. 9 is a connection diagram of the infrared remote controller based on voice control of the third embodiment and an infrared remote controller of electrical apparatus.

FIG. 10 is a block diagram of an infrared remote controller based on voice control according to a fourth embodiment.

FIG. 11 is a block diagram of an infrared remote controller based on voice control according to a fifth embodiment.

### DETAILED DESCRIPTION OF THE PREFERRED EMBODIMENTS

Several embodiments of the present disclosure will be described in greater detail with reference to the drawings. It should be noted that the figures are illustrative rather than limiting. The figures are not drawn to scale, do not illustrate every aspect of the described embodiments, and do not limit the scope of the present disclosure.

### Embodiment 1

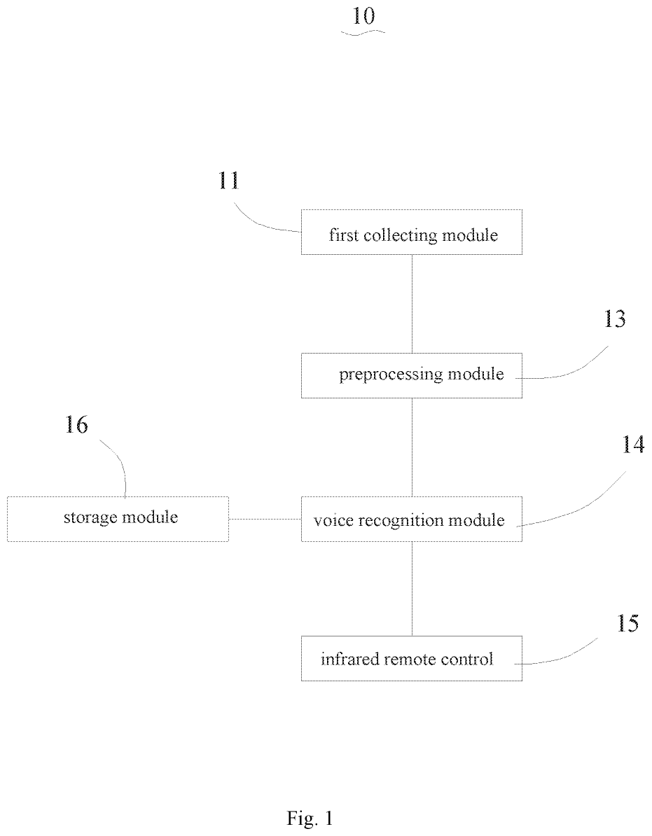

Referring to FIG. 1, an infrared remote controller 10 based on voice control in accordance with a first embodiment of the present disclosure includes a first collecting module 11, a preprocessing module 13, a voice recognition module 14, an infrared emitter 15, and a storage module 16. The storage module 16 is configured to store one or more preset voice commands including one or more preset voice features. The first collecting module 11 is configured to collect user's voice data, and the preprocessing module 13 is configured to preprocess the user's voice data collected by the first collecting module 11 to eliminate interferential voice to acquire target voice. The voice recognition module 14 is connected to the preprocessing module 13, the storage module 16, and the infrared emitter 15. The voice recognition module 14 is configured to extract voice feature from the target voice, compare the voice feature of the target voice with the preset voice features to acquire a comparison result, and send a first feedback signal to the infrared emitter 15 according to the comparison result. The infrared emitter 15 generates an infrared signal according to the first feedback signal, and modulates the infrared signal. Thus, the voice command may be used to control electrical apparatus having an infrared sensor, such as a refrigerator, an air conditioner, a fan, a television, etc. in a far range, the range is set according to a receiving range of the infrared sensor of the electrical apparatus and a transmitting range of the infrared signal sent by the infrared emitter 15.

The connection relationship in this embodiment refers to an electrical connection relationship and/or a signal connection relationship between two elements, which enable the signals to be transmitted between the two elements.

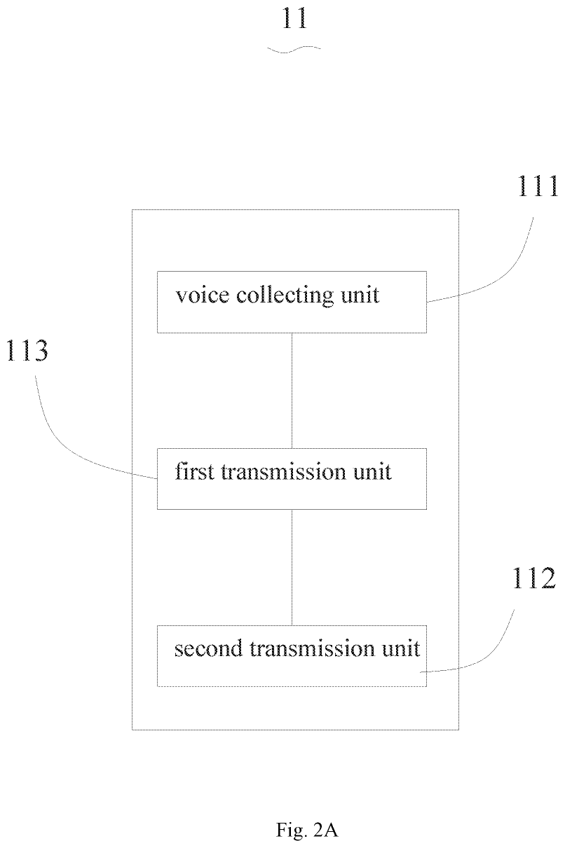

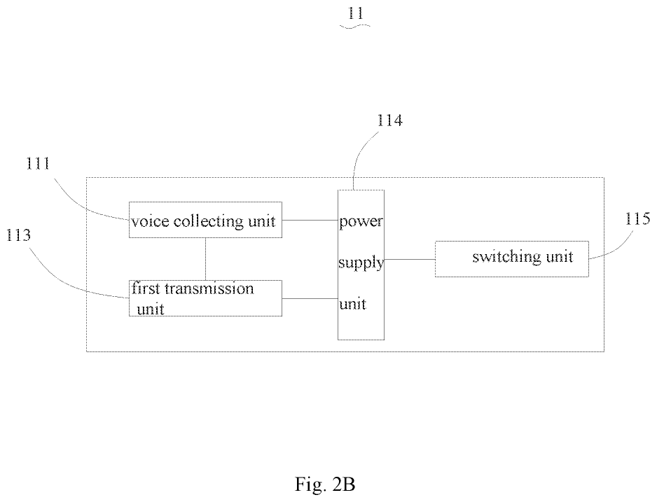

Referring to FIG. 2A, the first collecting module 11 includes a voice collecting unit 111 and a first transmission unit 113. The voice collecting unit 111 is configured to acquire the user's voice data. The voice collecting unit 111 may be but not limited to a single microphone or a microphone matrix, and the first transmission unit 113 may be but not limited to a Universal Serial Bus (USB) interface, a General Purpose Interface Bus (GPIB) interface, or an Electronic Industry Association Recommended Standard 232 (EIA-RS-232) interface.

The first transmission unit 113 is connected to the voice collecting unit 111 and is configured to transmit the user's voice data from the voice collecting unit 111 to the preprocessing module 13, and the preprocessing module 13 preprocesses the voice data and eliminates the interferential voice to acquire the target voice.

In several embodiments, the first collecting module 11 further includes an second transmission unit 112 electrically connected to the first transmission unit 113 and detachably connected to the preprocessing module 13 through plugging or magnetic adsorption. Therefore, the first collecting module 11 may be detachably connected to the preprocessing module 13 in socket joint mode through the second transmission unit 112, in order to easily replace the first collecting module 11 after being damaged. The first transmission unit 113 and the second transmission unit 112 are considered as a pair of matching interfaces of a transmission module.

In addition, the first collecting module 11 is detachably coupled to the preprocessing module 13 to wire communicate with the preprocessing module 13 through the second transmission unit 112, which ensures that the first collecting module 11 is stably communicated with the preprocessing module 13 and the preprocessing module 13 is better to process the signal transmission between the first collecting module 11 and the preprocessing module 13.

In this embodiment, the first transmission unit 113 and the preprocessing module 13 are communicated with each other using wire or not based on 3G network, 4G network, or Wi-Fi, and it is not limited herein.

Referring to FIG. 2B, in several embodiments, the first collecting module 11 further includes a power supply unit 114 and a switching unit 115. The power supply unit 114 is connected to and supplies power for the voice collecting unit 111 and the first transmission unit 113. The switching unit 115 is connected to the power supply unit 114, and is configured to turn on and off the power supply unit 114. The switching unit 115 may be a mechanical switch such as a button or a paddle, or an inductive switch such as a touch control or a voice control.

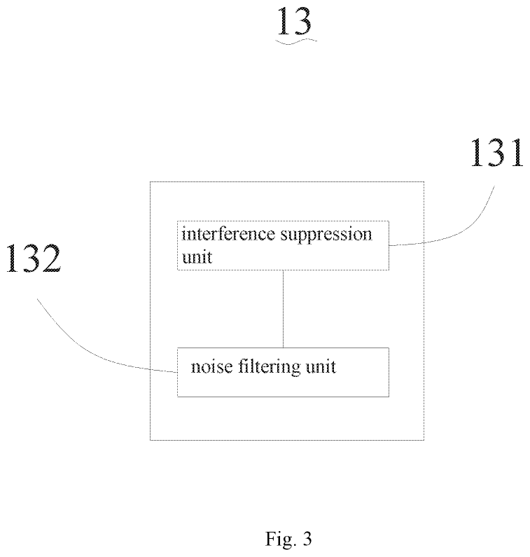

Referring to FIG. 3, the preprocessing module 13 includes an interference suppression unit 131 electrically connected to the first collecting module 11 and a noise filtering unit 132. The interference suppression unit 131 is configured to suppress the interference voice of the voice data collected by the first collecting module 11 during the voice data being transmitting. In detail, the interference suppression unit 131 is configured to improve a signal-to-noise ratio of the voice data collected by the first collecting module 11 to acquire the voice data with a high signal-to-noise ratio. The interference suppression unit 131 is a chip having a suppression function of disrobed above. Thus, the noise filtering unit 132 may filter well the voice data to acquire the target voice. The noise filtering unit 132 is electrically connected to the interference suppression unit 131 and is configured to filter an ambient noise and/or delete a blank voice to the voice data processed by the interference suppression unit 131 to acquire pure human voice data, the voice data processed by the interference suppression unit 131 is also the voice data with the high signal-to-noise ratio, and the pure human voice data is the target voice which is also called target voice data or target signal. The noise filtering unit 132 may be but not limited to a chip having a filtering function of disrobed above.

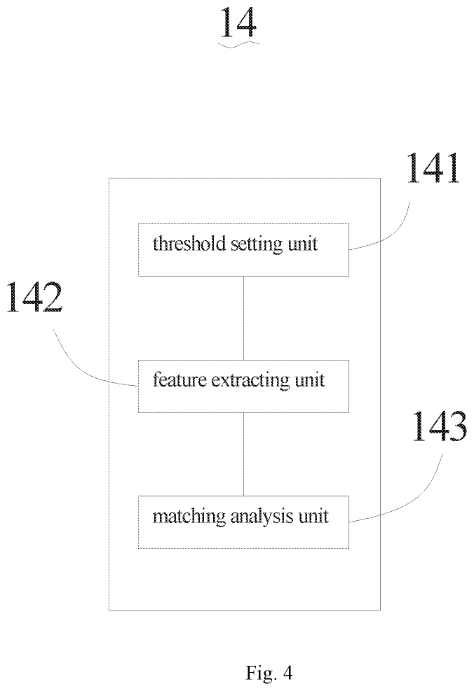

Referring to FIG. 4, the voice recognition module 14 includes a threshold setting unit 141, a feature extracting unit 142, and a matching analysis unit 143. The feature extracting unit 142 is configured to extract voice feature of the target voice from the preprocessing module 13, and the voice feature of the target voice may include one feature, two features or three features from features of sound intensity, loudness, pitch, and pitch period, and so on. The sound intensity refers to an average sound energy per unit area passing through a direction that is perpendicular to a sound wave propagation direction in per unit time, the loudness of the sound refers to a degree of sound intensity that we subjectively feel, the pitch refers to a feeling of human auditory system for sound frequency, and the pitch period refers to the time from turning on a vocal cord to turning off the vocal cord once. For example, a voice recognition used by the voice recognition module 14 may be a voice recognition based on a convolutional neural network algorithm and/or a voice recognition based on a voiceprint feature extraction. The voice recognition module 14 may be but not limited to a chip having a recognition function of disrobed above, and the feature extracting unit 142 may be but not limited to a chip having a function of extracting above-mentioned voice features.

The threshold setting unit 141 is configured to set a speech feature matching threshold. The threshold setting unit 141 receives a setting command input by an input device and sets the speech feature matching threshold, and the input device may be but not limited to some physical buttons, virtual soft buttons, and so on.

The matching analysis unit 143 is configured to compare the voice feature of the target voice acquired from the feature extracting unit 142 with the preset voice feature stored in the storage module 16, and send the first feedback signal to the infrared emitter 15 according to the comparison result. The infrared emitter 15 receives and analyzes the first feedback signal to generate and send the infrared signal to control the electrical apparatus. The matching analysis unit 143 may be a comparator or a comparing circuit.

Specifically, if a ratio of the voice feature of the target voice acquired from the feature extracting unit 142 to the preset voice feature stored in the storage module 16 is greater than or equal to the speech feature matching threshold set in the threshold setting unit 141, the matching analysis unit 143 sends a positive first feedback signal to the infrared emitter 15. The positive first feedback signal includes specific information of the infrared signal to be transmitted, that is, a code corresponding to the infrared signal. Thus, different infrared signals may be sent through different voice commands to control different electrical apparatuses or control the same apparatus to achieve various functions. The infrared emitter 15 receives and analyzes the first feedback signal to generate and send the infrared signal to control the electrical apparatus. If the ratio of the voice feature of the target voice acquired from the feature extracting unit 142 to the preset voice feature stored in the storage module 16 is smaller than the speech feature matching threshold set in the threshold setting unit 141, the matching analysis unit 143 sends a negative first feedback signal to the infrared emitter 15 or doesn't send the first feedback signal to the infrared emitter 15. Thus, the infrared emitter 15 doesn't send the infrared signal.

For example, it is assumed that the preset voice feature stored in the storage module 16 is an instruction statement “Please turn on the fan” from user A, and the first collecting module 11 collects voice data of instruction statement “Turn on the fan” or “Please turn on the fan” from the user A or user B. The preprocessing module 13 preprocesses the voice data of the instruction statements from the user A or the user B to eliminate interferential voice to acquire the target voice data of the instruction statement, the feature extracting unit 142 of the voice recognition module 14 extracts the voice feature from the target voice data to acquire the voice feature of the target voice, and the matching analysis unit 143 compares the voice feature of the target voice of the instruction statement “Turn on the fan” or “Please turn on the fan” from the user A or the user B acquired from the feature extracting unit 142 with the preset voice feature of the command statement “Please open the fan” from the user A. If the ratio is greater than or equal to the speech feature matching threshold set in the threshold setting unit 141, matching is successful, the matching analysis unit 143 sends the positive first feedback signal to the infrared emitter 15, and the infrared emitter 15 receives and analyzes the first feedback signal to generate and send the infrared signal to control the electrical apparatus. For example, the threshold is 90%, a ratio of the voice feature of the target voice of the instruction statement “Turn on the fan” or “Please turn on the fan” from the user A or user B acquired by the feature extracting unit 142 to the preset voice feature of the instruction statement “Please turn on the fan” from user A stored in the storage module 16 is greater than or equal to 90%, the matching is successful, the matching analysis unit 143 sends the positive first feedback signal to the infrared emitter 15, and the infrared emitter 15 receives and analyzes the first feedback signal to generate and send the infrared signal to control the electrical apparatus. Conversely, the matching analysis unit 143 sends the negative first feedback signal to the infrared emitter 15 or does not send the first feedback signal to the infrared emitter 15, the infrared emitter 15 doesn't send the infrared signal.

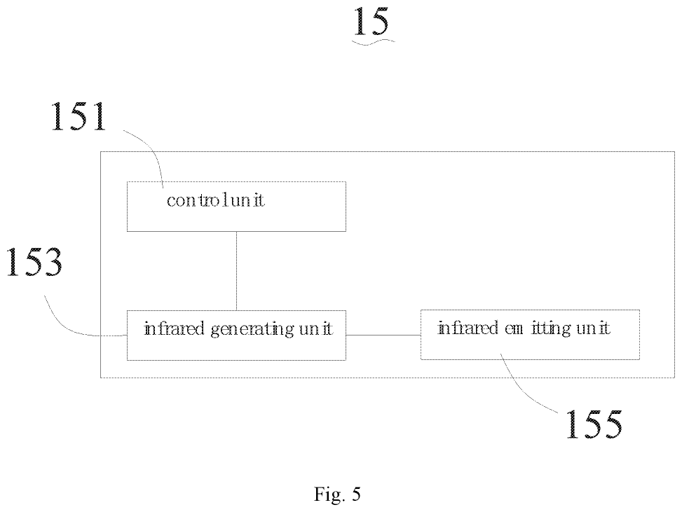

Referring to FIG. 5, the infrared emitter 15 includes a control unit 151, an infrared generating unit 153, and an infrared emitting unit 155. The control unit 151 is connected to the infrared generating unit 153 and the matching analysis unit 143 of the voice recognition module 14, and is configured to receive and analyze the first feedback signal sent by the matching analysis unit 143 to control the infrared generating unit 153 to generate the infrared signal according to the first feedback signal. The infrared emitting unit 155 is connected to the infrared generating unit 153 to send the infrared signal to the electrical apparatus having the infrared sensor, thus controlling the electrical apparatus.

Specifically, it is assumed that the positive first feedback signal is a binary code such as “0101”, “0100”. The binary code “0101” is mapped with a type A infrared signal controlling the fan to swing, and the binary code “0100” is mapped with a type B infrared signal controlling to turn on the fan.

When the signal from the matching analysis unit 143 is the positive first feedback signal, the control unit 151 analyzes the positive first feedback signal to acquire the binary code “0100”, and controls the infrared generating unit 153 to correspondingly yield the type B infrared signal. The infrared emitting unit 155 transmits the type B infrared signal to the electrical apparatus and controls the electrical apparatus to be on, that is, the fan is controlled to be on.

When the signal from the matching analysis unit 143 is the negative first feedback signal, or the control unit 151 doesn't receive the signal from the matching analysis unit 143, the infrared generating unit 153 does not operate.

In this embodiment, the preset voice command pre-stored in the storage module 16 may be one or more voice commands of one user, or may be a plurality of voice commands of many users. The plurality of voice commands may control the electrical apparatus to perform the same action, which is achieved through converting the plurality of voice commands into the same infrared signal having the same feature by the infrared emitter 15, and the infrared signal feature may be the wavelength and/or frequency of the infrared signal. The different voice commands may also be used to control the electrical apparatus to perform different actions, which is achieved through converting the different voice commands into the infrared signal having corresponding feature by the infrared emitter 15.

The speech feature matching threshold of the threshold setting unit 141 can be set according to user's preference. The speech feature matching threshold may be in a range of greater than 0 and less than 1. Particularly, assume the speech feature matching threshold value is α, 1>α≥65%, more particularly, 1>α≥90%.

In the disclosure, the user's preset voice command is stored locally by the storage module 16, and the preset voice command data can be used quickly without using the cloud to store the voice command. The first collecting module 11 is configured to receive the user's voice data, the interference suppression unit 131 of the preprocessing module 13 is configured to suppress the interference signal in the voice data from the first collecting module 11 to improve the signal-to-noise ratio of the voice data from the first collecting module 11, and the noise filtering unit 132 is configured to further eliminate the interference signal to effectively preserve the user's voice in the voice data, that is, the target voice. The voice recognition module 14 is configured to extract the voice feature of the target voice from the preprocessing module 13, and compare the voice feature of the target voice with the preset voice feature stored in the storage module 16. If the ratio of the voice feature of the target voice to the preset voice feature is greater than or equal to the speech feature matching threshold, the voice recognition module 14 sends the first feedback signal to the infrared emitter 15, and the infrared emitter 15 generates and sends the infrared signal to control the electrical apparatus.

### Embodiment 2

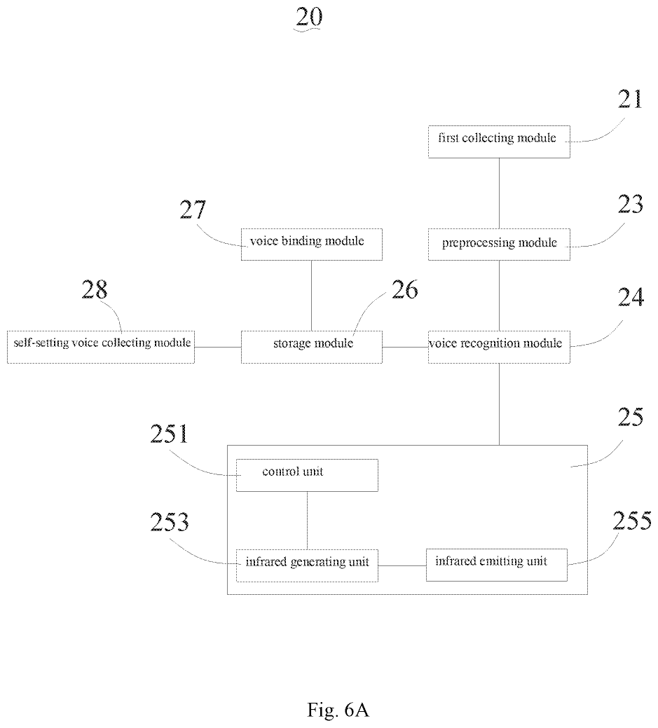

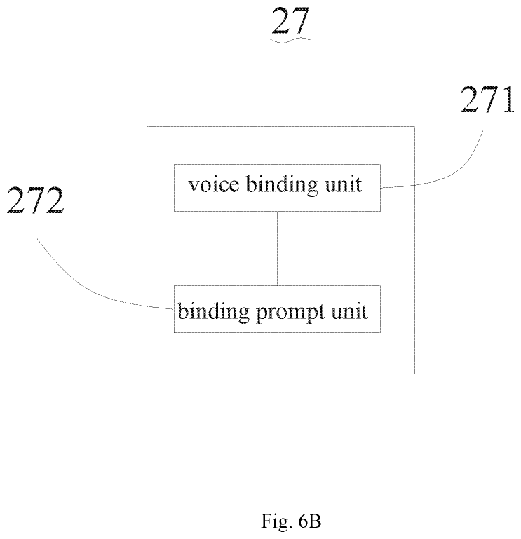

Referring to FIGS. 6A-6B, an infrared remote controller 20 based on voice control in accordance with a second embodiment includes a first collecting module 21, a preprocessing module 23, a voice recognition module 24, a storage module 26, and an infrared emitter 25.

The first collecting module 21, the preprocessing module 23, the voice recognition module 24, the infrared emitter 25, and the storage module 26 in the second embodiment and the first collecting module 11, the preprocessing module 13, the voice recognition module 14, the infrared emitter 15, and the storage module 16 in the first embodiment have the same connection relationship and functions, and are not described herein.

The second embodiment is different from the first embodiment in that the infrared remote controller 20 based on voice control further includes a self-setting voice collecting module 28 and a voice binding module 27. The self-setting voice collecting module 28 is connected to the storage module 26 and is configured to collect a user's self-setting voice command, extract and send a self-setting voice feature of the user's self-setting voice command to the storage module 26. The voice binding module 27 is configured to bind the self-setting voice feature with the preset voice feature, thus, the user can control the electrical apparatus through the self-setting voice.

Specifically, the voice binding module 27 includes a voice binding unit 271 and a binding prompt unit 272. The voice binding unit 271 is connected to the binding prompt unit 272, and is configured to bind the self-setting voice feature with the preset voice feature and send a binding feedback signal to the binding prompt unit 272 after the binding is successful. The binding prompt unit 272 receives the binding feedback signal, and sends a prompt message to the user to indicate that the binding is successful. The prompt message may be a flash, a text, or a voice. Preferably, the prompt message is the voice. The voice binding unit 271 may be but not limited to a Microcontroller Unit (MCU).

A method of collecting the self-setting voice feature used by the self-setting voice collection module 28 can refer to the method of collecting and processing the voice command used by the first collecting module 21 and the preprocessing module 23, and it will not be described again.

For example, the preset voice command “Turn on the fan” corresponds to turning on the fan. When the user wants to turn on the fan with the self-setting voice command “OPEN”, the self-setting voice feature of the self-setting voice command “OPEN” is collected by the self-setting voice collection module 28, the voice binding unit 271 binds or associates the self-setting voice feature of the self-setting voice command “OPEN” with the preset voice feature of the preset voice command “Turn on the fan”, and the binding prompt unit 272 sends a voice “Congratulation, the binding is successful” after the binding is successful. Therefore, the user can turn on the fan through the voice command “OPEN”.

In the embodiment, the user effectively extends the preset voice command through the self-setting voice collection module 28 and the voice binding module 27. Thus, the plurality of voice commands can be used to control the same action of the electrical apparatus, thereby effectively avoiding the user's inability to control the electrical apparatus because of forgetting the voice command.

### Embodiment 3

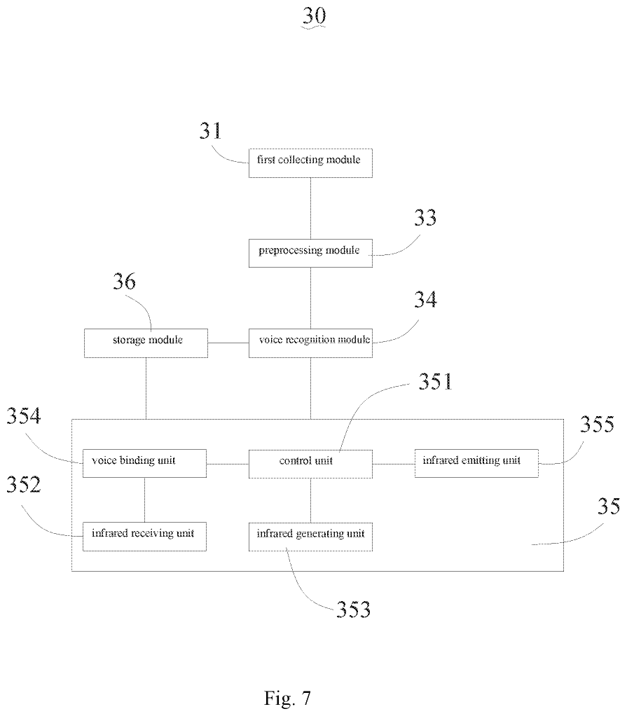

Referring to FIG. 7, an infrared remote controller 30 based on voice control in accordance with a third embodiment includes a first collecting module 31, a preprocessing module 33, a voice recognition module 34, and a storage module 36, and an infrared emitter 35.

The first collecting module 31, a preprocessing module 33, the voice recognition module 34, and the storage module 36 in the third embodiment and the first collecting module 11, the preprocessing module 13, the voice recognition module 14, and the storage module 16 in the first embodiment have the same connection relationship and functions, and are not described herein.

The third embodiment is different from the first embodiment in that the infrared emitter 35 includes a control unit 351, an infrared receiving unit 352, an infrared generating unit 353, a voice binding unit 354, and an infrared emitting unit 355. The control unit 351, the infrared generating unit 353, and the infrared emitting unit 355 of the third embodiment have the same connection relationship and function as the control unit 151, the infrared generating unit 153, and the infrared emitting unit 155 of the first embodiment, and are not described herein.

The infrared receiving unit 352 is connected to the storage module 36 and the control unit 351, and is configured to receive and analyze an infrared signal command sent from a remote controller of the electrical apparatus to control the electrical apparatus into an analyzed infrared signal command, and store the analyzed infrared signal command in the storage module 36.

The voice binding unit 354 is connected to the storage module 36 and the control unit 351, and is configured to bind the analyzed infrared signal command with a preset voice command pre-stored in the storage module 36, such that the user can turn on different electrical apparatus by using voice commands, or enable the same electrical apparatus perform the different functions.

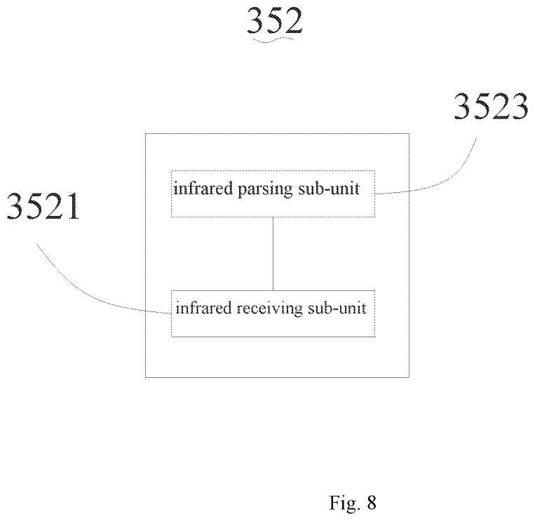

Referring to FIG. 8, specifically, the infrared receiving unit 352 includes an infrared receiving sub-unit 3521 and an infrared parsing sub-unit 3523, and the infrared receiving sub-unit 3521 is connected to the control unit 351 and the infrared parsing sub-unit 3523 for receiving an infrared signal sent by the remote controller of the electrical apparatus.

The infrared parsing sub-unit 3523 is connected to the storage module 36 for parsing the infrared signal sent by the infrared receiving sub-unit 3521 to acquire data of an analyzed infrared signal, storing the analyzed infrared signal data in the storage module 36, and associating the analyzed infrared signal data with the infrared generating unit.

The voice binding unit 354 is connected to the storage module 36 or connected to the storage module 36 and the control unit 351, and is configured to bind the analyzed infrared signal data from the infrared parsing sub-unit 3523 with user's preset voice command. After the user's preset voice command is recognized, the control unit 351 controls the infrared generating unit 353 to send the infrared signal corresponding to the voice command to the electric apparatus to control the electrical apparatus.

In the embodiment, by setting the infrared receiving unit 352 and the voice binding unit 354, the learning of the infrared signal corresponding to the control of the electrical apparatus can be effectively expanded, and the control of the infrared remote controller for a plurality of electrical apparatus having the infrared remote controller function is effectively expanded.

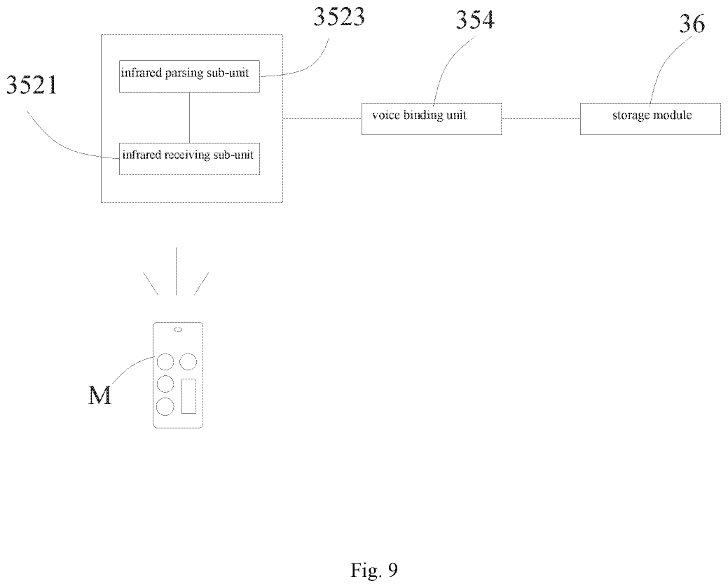

As shown in FIG. 9, M is the remote controller of the electrical apparatus, and the electrical apparatus is taken as an example of the fan, and the example is described in which the fan is required to make a swinging motion by the voice command.

When the user wants the fan to swing through the infrared remote controller 30 based on voice control, the infrared signal corresponding to the swing motion is sent by the remote controller M through pressing or touching the swing function button of the remote controller M. The infrared receiving sub-unit 3521 receives the infrared signal corresponding to the swinging motion; the infrared parsing sub-unit 3523 analyzes the infrared signal corresponding to the swing motion to generate corresponding analyzed infrared signal data, stores the analyzed infrared signal data in the storage module 36, and associates the analyzed infrared signal with the infrared generating unit 353.

Collecting the voice command corresponding to the swing motion of the fan, such as the voice command of “shaking the head” or “swinging the head”, extracting a voice feature of the voice command, and storing the voice feature corresponding to the swing motion in the storage module 36. Or, the voice feature of the voice command that has been stored in the storage module 36 for the fan to perform the swing motion is bound with the analyzed infrared signal data generated by the infrared parsing sub-unit 3523 through the voice binding unit 354.

After the binding is successful, the fan can make the swing motion through collecting user's voice command corresponding to the swing motion of the fan by the first collecting module 31.

In several embodiments, the infrared generating unit 353 further includes a binding prompt unit (not shown), and the binding prompt unit is connected to the control unit 351. The binding prompt unit is configured to send the message of successful binding to the user after the voice binding unit 354 finishes to bind the user's voice command with the analyzed infrared signal data from the infrared parsing sub-unit 3523. Conversely, sending the message of the binding failure. The binding prompt unit may be a voice prompt or a shining prompt, so that the user can know in time whether the binding of the voice command is successful.

In the embodiment, by providing the infrared receiving unit 352 and the voice binding unit 354, the infrared remote controller 30 based on voice control may learn the infrared signal of the electrical apparatus in time according to the need, and bind the infrared signal with the user's corresponding voice command. Thus, the user can control the electrical apparatus through specific voice commands.

### Embodiment 4

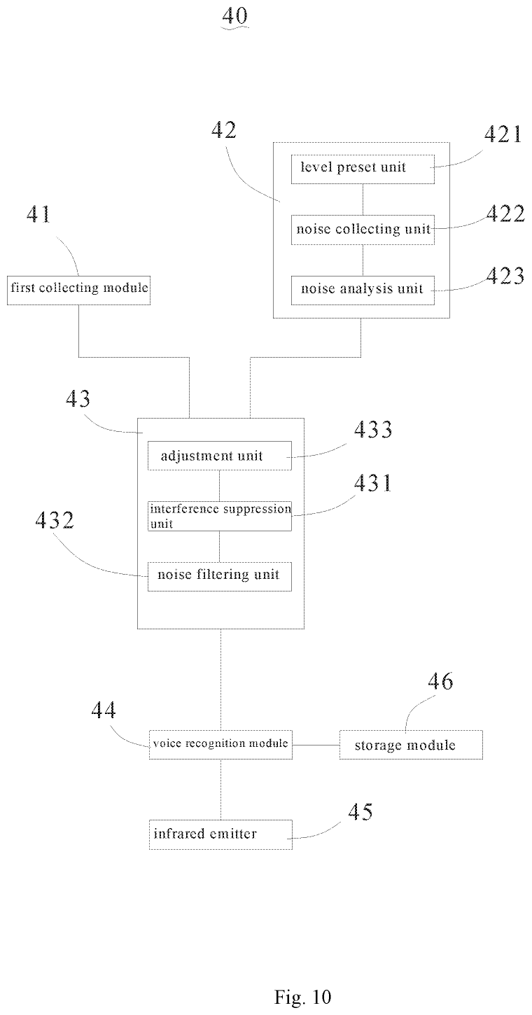

Referring to FIG. 10, an infrared remote controller 40 based on voice control in accordance with a fourth embodiment of the present disclosure includes a first collecting module 41, a second collecting module 42, a preprocessing module 43, a voice recognition module 44, a storage module 46, and an infrared emitter 45.

The first collecting module 41, the voice recognition module 44, the storage module 46, and the infrared emitter 45 in the embodiment and the first collecting module 11, the voice recognition module 14, the storage module 16, and the infrared emitter 15 in the first embodiment have the same connection relationship and function, and are not described herein.

The second collecting module 42 is connected to the preprocessing module 43, and is configured to acquire an ambient noise and analyze a noise level of the ambient noise, and feedback the noise level of the ambient noise to the preprocessing module 43, the preprocessing module 43 adjusts a noise filtering intensity according to the noise level of the ambient noise.

Specifically, the second collecting module 42 includes a level preset unit 421, a noise collecting unit 422, and a noise analysis unit 423. The level preset unit 421 is configured to preset the noise level, and the noise collecting unit 422 is configured to collect the ambient noise where the infrared remote controller 40 is located. The noise analysis unit 423 is connected to the level preset unit 421 and the noise collecting unit 422, and is configured to compare the ambient noise collected by the noise collecting unit 422 with the preset noise level of the level preset unit 421, determine the level of the noise collected by the noise collecting unit 422, and send a second feedback signal of the noise level to the preprocessing module 43, and the preprocessing module 43 adjusts the noise filtering intensity according to the noise level.

The preprocessing module 43 includes an adjustment unit 433, an interference suppression unit 431, and a noise filtering unit 432. The interference suppression unit 431 and/or the noise filtering unit 432 are provided with a plurality of intensity levels, and the adjustment unit 433 is connected to the noise analysis unit 423, the interference suppression unit 431, and the noise filtering unit 432. The adjustment unit 433 is configured to adjust interference suppression strength of the interference suppression unit 431 and/or filtering strength of the noise filtering unit 432 according to the noise level determined by the noise analysis unit 423 to acquire a relative good target voice, which increases the sound recognition effect.

For example, setting the sound of 20-40 decibels to be the first-level noise, setting the sound of 40-60 decibels to be the second-level noise, setting the sound of 60-90 decibels to the third-level noise, and setting the sound of more than 90 decibels to fourth-level noise. When the ambient noise collected by the noise collecting unit 422 is between 40 and 60 decibels, the noise analysis unit 423 determines that the ambient noise is the second-level noise, and generates and sends a second-level-noise second feedback signal to the adjustment unit 433, and thus the adjustment unit 433 may adjust the interference suppression strength of the interference suppression unit 431 and/or the filtering strength of the noise filtering unit 432 according to the second feedback signal.

It can be understood that, in several embodiments, the infrared remote controller 40 based on voice control concludes a self-setting voice collecting module and a voice binding module. The self-setting voice collecting module and the voice binding module in the embodiment and the self-setting voice collecting module 28 and the voice binding module 27 in the second embodiment have the same connection relationship and functions, and are not described herein.

It also can be understood that, in several embodiments, the first collecting module 41, the voice recognition module 44, the storage module 46, and the infrared emitter 45 in the embodiment and the first collecting module 31, the voice recognition module 34, the storage module 36, and the infrared emitter 35 in the third embodiment have the same connection relationship and functions, and are not described herein.

In the embodiment, the second collecting module 42 is configured to acquire the ambient noise, analyze the noise level of the ambient noise, and send the second feedback signal of the noise level to the preprocessing module 43, and thus the preprocessing module 43 may adjust the filtering strength of the noise according to the different noise levels to acquire the relative good target voice, which increases the sound recognition effect.

### Embodiment 5

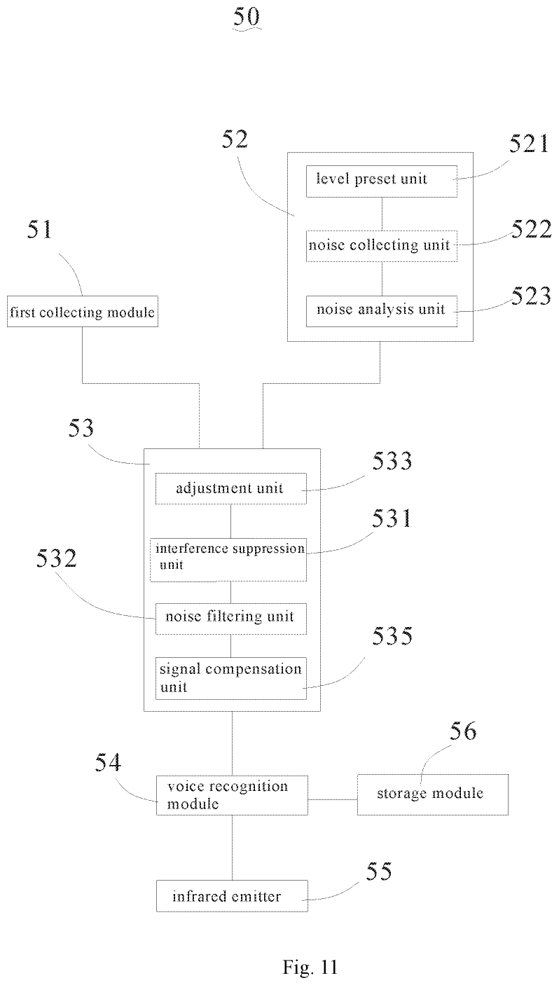

Referring to FIG. 11, an infrared remote controller 50 based on voice control in accordance with a fifth embodiment of the present disclosure includes a first collecting module 51, a second collecting module 52, a preprocessing module 53, a voice recognition module 54, a storage module 56, and an infrared emitter 55.

The first collecting module 51, the second collecting module 52, the voice recognition module 54, the storage module 56, and the infrared emitter 55 in the embodiment and the first collecting module 41, the second collecting module 42, the voice recognition module 44, the storage module 46, and the infrared emitter 45 in the fourth embodiment have the same connection relationship and function, and are not described herein.

The fifth embodiment is different from the fourth embodiment in that the preprocessing module 53 includes an adjustment unit 533, an interference suppression unit 531, a noise filtering unit 532, and a signal compensation unit 535. The adjustment unit 533, the interference suppression unit 531, and the noise filtering unit 532 in the embodiment have the same connection relationship and function as the adjustment unit 433, the interference suppression unit 431 and the noise filtering unit 432 corresponding to the fourth embodiment, and are not described herein.

The signal compensation unit 535 is connected to the noise filtering unit 532, and is configured to compensate data loss of the voice command when the interference suppression unit 531 and the noise filtering unit 532 process the noise. The compensation amount may be a fixed value or be set according to the noise level of the collected ambient noise, thus improving the conversion capacity on the voice command.

### Embodiment 6

A control system for an electrical apparatus in accordance with a sixth embodiment includes an electrical apparatus and an infrared remote controller based on voice control. The infrared remote controller based on voice control and anyone of the infrared remote controller 10 based on voice control provided by the first embodiment, the infrared remote controller 20 based on voice control provided by the second embodiment, the infrared remote controller 30 based on voice control provided by the third embodiment, the infrared remote controller 40 based on voice control provided by the fourth embodiment, and the infrared remote controller 50 based on voice control provided by the fifth embodiment have the same connection relationship and function, and are not described herein. In the control system for the electrical apparatus, the infrared remote controller based on voice control converts the user's voice command into the corresponding infrared signal, and the electrical apparatus receives, analyzes, and recognizes the infrared signal, thus remotely controlling the electrical apparatus.

Compared with the prior art, the infrared remote controller based on voice control of the disclosure has the following advantages:

Firstly, the user's preset voice command is stored locally by the storage module, and the preset voice command data can be used quickly without using the cloud to store the voice command. The first collecting module is configured to receive the user's voice data, the interference suppression unit of the preprocessing module is configured to suppress the interference signal in the voice data from the first collecting module to improve the signal-to-noise ratio of the voice data from the first collecting module, and the noise filtering unit is configured to further eliminate the interference signal to effectively preserve the user's voice in the voice data, that is, the target voice. The voice recognition module is configured to extract the voice feature of the target voice from the preprocessing module, and compare the voice feature of the target voice with the preset voice feature stored in the storage module. If the ratio of the voice feature of the target voice to the preset voice feature is greater than or equal to the speech feature matching threshold, the voice recognition module sends the first feedback signal to the infrared emitter, and the infrared emitter sends the infrared signal to control the electrical apparatus.

Further, the first collecting module is detachably connected to the preprocessing module in a wired manner, which ensures the signal transmission between the first collecting module and the preprocessing module to be stable, thereby improving preprocessing effect of the preprocessing module.

Secondly, the user may effectively extend the preset voice command through the self-setting voice collection module and the voice binding module. Thus, the plurality of voice commands can be used to control the same action of the electrical apparatus, thereby effectively avoiding the user's inability to control the electrical apparatus because of forgetting the voice command.

Thirdly, the second collecting module is configured to acquire the ambient noise, analyze the noise level of the ambient noise, and send the second feedback signal of the noise level to the preprocessing module, and thus the preprocessing module may adjust the filtering strength of the noise according to the different noise levels to acquire the relative good target voice, which increases the sound recognition effect.

The above embodiments are only the preferred embodiments of the present invention, and do not limit the scope of the present invention. A person skilled in the art may make various other corresponding changes and deformations based on the described technical solutions and concepts. And all such changes and deformations shall also fall within the scope of the present invention.

What is claimed is:

1. An infrared remote controller based on voice control comprising:
a first collecting module collecting user's voice data;
a voice recognition module recognizing a command from the user's voice data and generating an electrical signal according to the command; and
an infrared emitter converting the electrical signal to an infrared signal and sending the infrared signal to an electrical apparatus to control the electrical apparatus.

2. The infrared remote controller of claim 1, wherein the infrared remote controller further comprises a preprocessing module, the preprocessing module preprocesses the user's voice data collected by the first collecting module to acquire target voice.

3. The infrared remote controller of claim 2, wherein the infrared remote controller further comprises a storage module storing preset voice commands comprising a preset voice feature.

4. The infrared remote controller of claim 3, wherein the preprocessing module comprises an interference suppression unit electrically connected to the first collecting module and a noise filtering unit; the interference suppression unit processes the user's voice data collected by the first collecting module to acquire a voice data with a high signal-to-noise ratio; the noise filtering unit is electrically connected to the interference suppression unit, and processes the voice data with the high signal-to-noise ratio to acquire the target voice.

5. The infrared remote controller of claim 3, wherein the infrared emitter is connected to the voice recognition module, the infrared emitter receives and analyzes a first feedback signal sent by the voice recognition module to generate the infrared signal according to the first feedback signal, and sends the infrared signal to the electrical apparatus.

6. The infrared remote controller of claim 3, wherein the infrared emitter comprises an infrared receiving unit and a voice binding unit; the infrared receiving unit is connected to the storage module and a control unit, and receives and analyzes the infrared signal into data of an analyzed infrared signal, and stores the data of the analyzed infrared signal in the storage module; the voice binding unit is connected to the storage module, and binds the data of the analyzed infrared signal with the preset voice command pre-stored in the storage module.

7. The infrared remote controller of claim 4, wherein the infrared remote controller further comprises a second collecting module connected to the preprocessing module; the second collecting module acquires an ambient noise, and analyzes and feeds back a noise level of the ambient noise to the preprocessing module, and the preprocessing module adjusts a noise filtering intensity according to the noise level of the ambient noise.

8. The infrared remote controller of claim 7, wherein the preprocessing module further comprises a signal compensation unit, and the signal compensation unit is connected to the noise filtering unit, the signal compensation unit compensates data loss of voice commands when the interference suppression unit and the noise filtering unit process noise.

9. A control system for an electrical apparatus, comprising:
an electrical apparatus; and
an infrared remote controller based on voice control;
wherein the infrared remote controller comprises a first collecting module collecting user's voice data, a voice recognition module recognizing a command from the user's voice data and generating an electrical signal according to the command, and an infrared emitter converting the electrical signal to an infrared signal and sending the infrared signal to the electrical apparatus to control the electrical apparatus.

10. The control system for the electrical apparatus of claim 9, wherein the infrared remote controller further comprises a preprocessing module, the preprocessing module preprocesses the user's voice data collected by the first collecting module to acquire target voice.

11. The control system for the electrical apparatus of claim 10, wherein the infrared remote controller further comprises a storage module storing preset voice commands comprising the preset voice feature.

12. The control system for the electrical apparatus of claim 11, wherein the preprocessing module comprises an interference suppression unit electrically connected to the first collecting module and a noise filtering unit; the interference suppression unit processes the user's voice data collected by the first collecting module to acquire a voice data with a high signal-to-noise ratio; the noise filtering unit is electrically connected to the interference suppression unit, and processes the voice data with the high signal-to-noise ratio to acquire the target voice.

13. The control system for the electrical apparatus of claim 11, wherein the infrared emitter is connected to the voice recognition module, the infrared emitter receives and analyzes a first feedback signal sent by the voice recognition module to generate the infrared signal according to the first feedback signal, and sends the infrared signal to the electrical apparatus.

14. The control system for the electrical apparatus of claim 11, wherein the infrared emitter further comprises an infrared receiving unit and a voice binding unit; the infrared receiving unit is connected to the storage module and a control unit, and receives and analyzes the infrared signal into data of an analyzed infrared signal, and stores the data of the analyzed infrared signal in the storage module; the voice binding unit is connected to the storage module, and binds the data of the analyzed infrared signal with the preset voice command pre-stored in the storage module.

15. The control system for the electrical apparatus of claim 12, wherein the infrared remote controller further comprises a second collecting module connected to the preprocessing module; the second collecting module acquires an ambient noise, and analyzes and feeds back a noise level of the ambient noise to the preprocessing module, and the preprocessing module adjusts a noise filtering intensity according to the noise level of the ambient noise.

16. The control system for the electrical apparatus of claim 15, wherein the preprocessing module further comprises a signal compensation unit, and the signal compensation unit is connected to the noise filtering unit, the signal compensation unit compensates data loss of voice commands when the interference suppression unit and the noise filtering unit process noise.
